(19) United States
(12) Patent Application Publication
(10) Pub. No.: US 2008/0046706 A1
(43) Pub. Date: Feb. 21, 2008

(54) Remote Monitor Module for Computer Initialization

(75) Inventors: Tomonori Hirai, Fremont, CA (US); Jyh Ming Jong, Fremont, CA (US)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: TYAN COMPUTER CORPORATION, Taipei (TW)

(21) Appl. No.: 11/555,232

(22) Filed: Oct. 31, 2006

Related U.S. Application Data
(60) Provisional application No. 60/822,424, filed on Aug. 15, 2006.

(51) Int. Cl. G06F 15/177; G06F 9/24

(52) U.S. Cl. 713/1

(57) ABSTRACT

A remote monitor module is provided to monitor initialization events of a computer host domain on a local mainboard. The remote module includes an event monitor to detect certain initialization events during system initialization process, and then generates and transmits event signals to a BMC (Baseboard Management Controller). A decoder may be used to decode BIOS check data at a specific I/O address and provides check data signals to the BMC. The BMC receives the event signals and/or the check data signals and transmits to a remote management host through remote management link(s).

### BACKGROUND OF THE INVENTION

1. Field of Invention

The present invention relates to computer initialization, and more particularly to a remote monitor module for computer initialization.

2. Related Art

Currently, most local mainboards have specific debugging, testing and trouble shooting features during system initialization process. However, those features are not always accessible for an external device or a remote management host. Most of these features are just board-level functions. Besides, the progress of the testing tasks is only shown on the on-board indicators (such as 7-segment LEDs). Unless the indicators are configured outside the chassis, to monitor those tasks requires external test equipments. For a blade or cluster system, these indicators can provide only poor system-level management in system initialization stage.

FIG. 1 shows a typical legacy implementation for local mainboards of a computer system in the prior art. Local mainboard 01 includes a computer host domain 10 that operates as a computer. The computer host domain 10 mainly includes CPU(s) 11, system memory (not shown), a BIOS 13 (or initialization codes) embedded on a memory, a system chipset(s) 12 connected between the CPU 11 and the BIOS 13, power supplies and other system components (both not shown). A system I/O bus 40, such as LPC (Low Pin Count) or PCI-based bus connects the computer host domain 10 with a decoder 30 and other I/O devices (not shown). A BMC (Baseboard Management Controller) 20 is in circuit connection with the computer host domain 10 and provides remote monitor/control capability to the remote management host through the remote management link(s).

In the system initialization process, there are two major portions. One is before first fetching the initialization codes (BIOS) and the other is after starting to fetch the BIOS. Once the BIOS initializes output devices such as the video display and/or the serial ports, there are certain software programs in the prior art to process system bring-up, testing and trouble shooting. However, some certain information such as BIOS check data (including check point information for indicating the BIOS initialization stage instantly), are not available through these software programs. The check data are generally provided in the duration between first fetching the BIOS and the output device initialization.

A monitor function called “Port 80” feature, generally used in an x86-based computer system for monitoring BIOS debug progress, is provided by the decoder 30 that responds to an I/O address “0x0080” (or Port 80) on the system I/O bus 40. During BIOS initialization process, the BIOS 13 writes the aforesaid check data to the decoder 30 through the system I/O bus 40. Then the decoder 30 decodes the check data and displays on the indicator 31. These visible check data on the indicator 31 allow users to identify and locate the problems of system hardware when the system initialization process is stuck somewhere. However, the BMC 20 with general capability does not support this function. Since the legacy BMC 20 and the decoder 30 are independent to each other, the remote management host in the prior art is not able to monitor the check data through the BMC 20.

Except the check data, initialization events in the system initialization process such as power good status, releasing reset(s), first BIOS fetch and etc., are already provided by the bus protocols of the system I/O bus 40 (like first instruction fetch from the BIOS, releasing reset), some other specific monitor circuits (like temperature, fan speed, power good status), or directly from the hardware components (like power supply). However, the general BMC 20 is not designed for the customized functions of accessing these initialization events. And no other monitor devices in the prior art handles these customized monitoring tasks and send for display. Therefore, the initialization events are not sent or displayed on the indicator 30, nor provided to the remote management host. To observe the system initialization events, generally users have to use a scope or logic analyzer.

### SUMMARY OF THE INVENTION

Accordingly, the present invention provides the system initialization information to a remote management host through a remote monitor module. Basically, extra circuit(s) on a local mainboard will be provided to capture the system status information and send to a local management circuit such as BMC. Then remote management host can access that information through remote management link(s).

In an embodiment of the present invention, the remote monitor module is to monitor a computer host domain on a local mainboard. The computer host domain includes CPU(s), BIOS and system chipset(s) operating as a bridge interface between the CPU and the BIOS. The remote management module includes a BMC (Baseboard Management Controller) and an event monitor. The BMC is in circuit connection with the computer host domain and a remote management host. The event monitor is in circuit connection with the computer host domain and the BMC, detecting a status signals corresponding to the initialization event and generating and transmitting event signals to the BMC.

In another embodiment of the present invention, the event monitor includes a condition checker and an event latch. The condition checker is to confirm whether the status signal is at a designed voltage level, while the event latch is for latching to remain the event signal at a specific voltage level and transmitting to the BMC. In some situations, the event monitor further includes a synchronizer for synchronizing the status signal with a system clock of the computer host domain and transmitting the synchronized status signal to the condition checker.

In another embodiment of the present invention, the system chipset is connected with the BIOS through a system I/O bus. The remote monitor module further includes a decoder that connects with the system I/O bus. The decoder decodes check data (check point information) written by the BIOS, and generates and transmits check data signals to the BMC. The remote monitor module may further comprise a bus multiplexer that receives and selects one of the event signal and the check data signal according to selection signals from the BMC, and sends the selected event signal or check data signal to the BMC.

In another embodiment of the present invention, the remote monitor module further includes a GPIO (General Purpose Input/Output) device to provide GPIO pins for receiving the event signal and the check data signal. Both the BMC and the GPIO device connect to a SMBus (System Management Bus) extended from the system chipset of the computer host domain. Thus, the event signal and the check data signal may be accessed by the BMC through the SMBus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram for local mainboards in the prior art, showing a legacy implementation of board-level local management.

FIG. 2 is a block diagram of local mainboards equipped with a remote monitor module according to an embodiment of the present invention.

FIG. 2A is a block diagram for an event monitor according to an embodiment of the present invention.

FIG. 2B is a block diagram of a specific event monitor according to another embodiment of the present invention, showing the actual application to monitor the first BIOS fetch event.

FIG. 2C is a block diagram of a decoder according to another embodiment of the present invention, showing the actual application to decode the check data written by the BIOS.

FIG. 3 is a block diagram of local mainboards equipped with a remote monitor module according to another embodiment of the present invention.

FIG. 4 is a block diagram of local mainboards equipped with a remote monitor module according to another embodiment of the present invention.

FIG. 5 is a detailed block diagram showing the actual application of the local mainboard in FIG. 4.

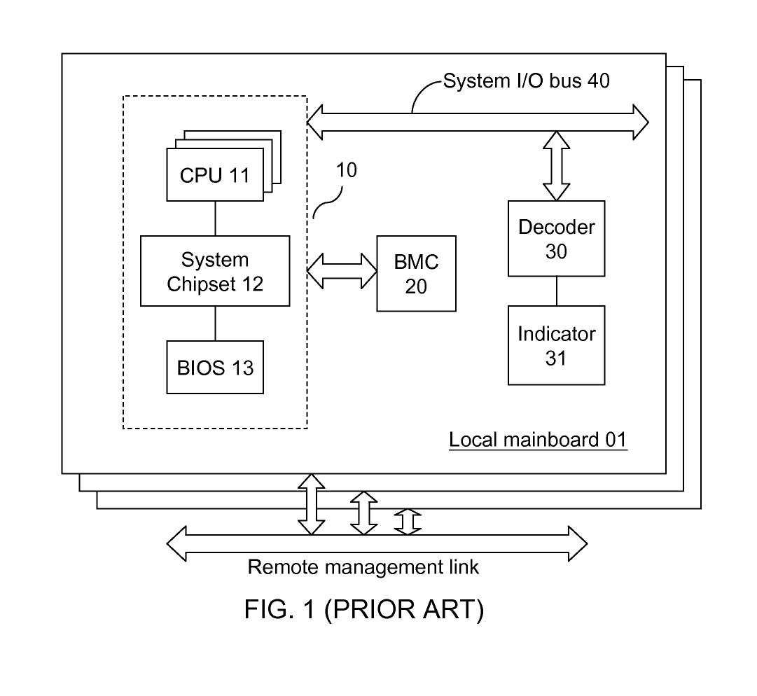

### DETAILED DESCRIPTION OF THE INVENTION

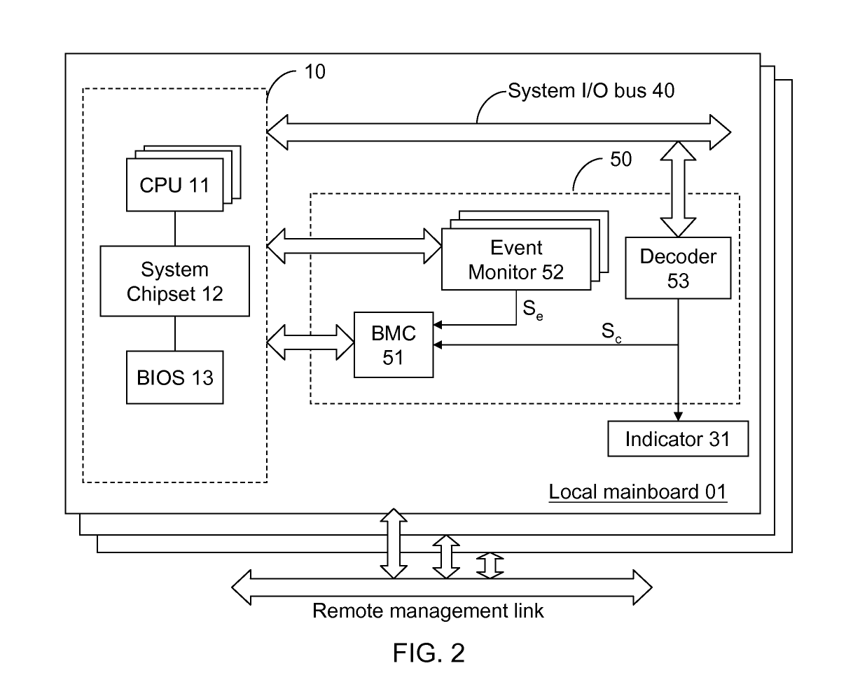

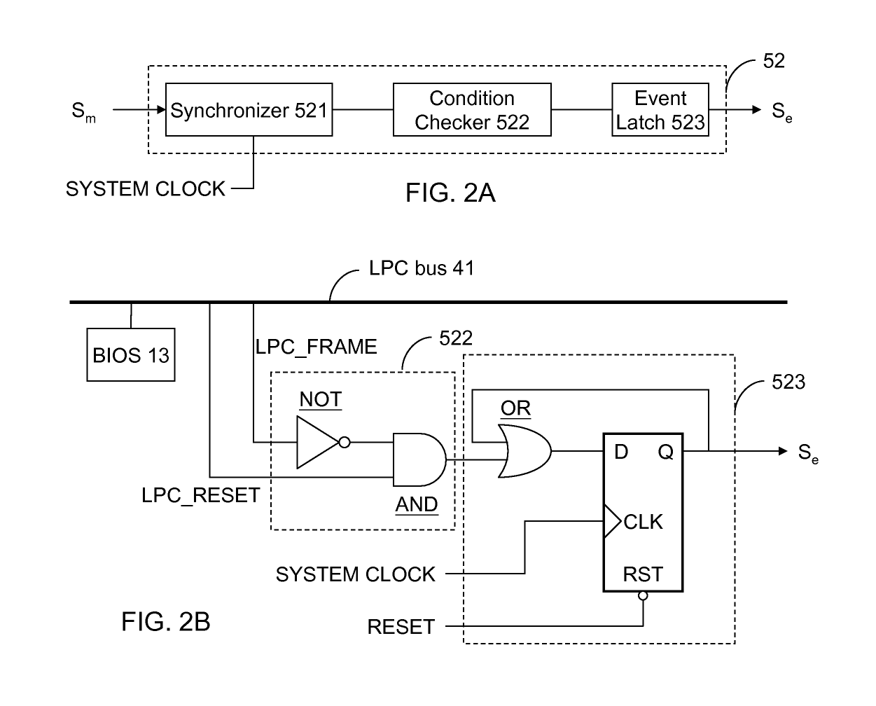

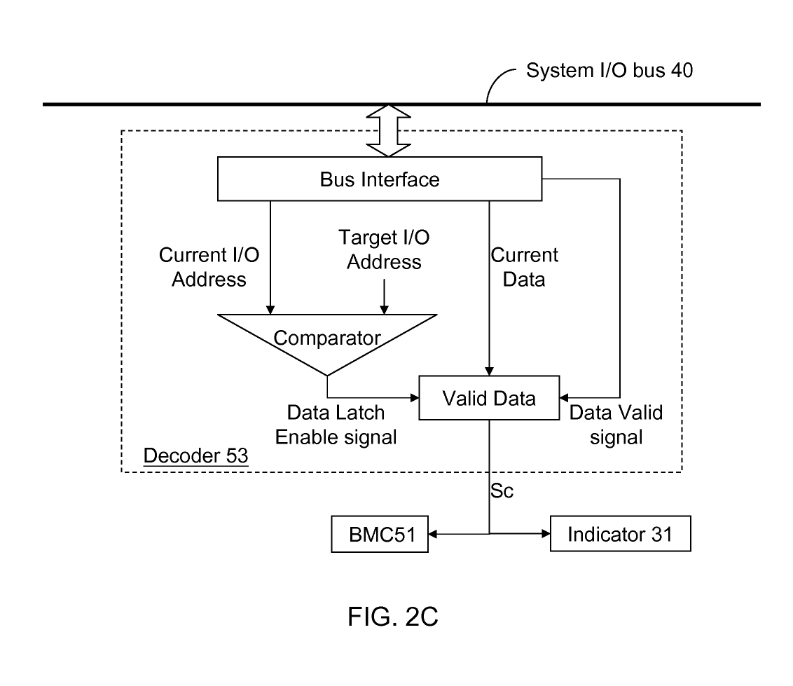

Please refer to FIG. 2. Plural local mainboards 01 are combined as a computing system. Each of the local mainboards 01 connected with a remote management host (not shown) through remote management link(s). The remote management link may be compatible with the communication links defined in the IPMI (Intelligent Platform Management Interface) Specification, such as the communication links through system I/O bus, Network Interface (NIC controller and connector), Serial Port, and even SMBus (System Management Bus) between local mainboards.

The local mainboard 01 mainly includes a computer host domain 10, a system I/O bus 40 and a remote monitor module 50.

The computer host domain 10 operates as a computer, generally including CPU(s) 11, system memory (not shown), a BIOS 13, a system chipset(s) 12 connected between the CPU 11 and the BIOS (Basic Input/Output System) 13, power supplies (not shown) and other system components (not shown). In some implementation the CPU has a memory controller therein, such as AMD (Advanced Micro Devices, Inc.) based x86 processors, to access the system memory directly. For those CPUs equipped with no memory controller, a memory hub or North Bridge is necessary for the CPUs to access the system memory.

The so-called BIOS 13 includes bootable image or initialization codes, usually stored/embedded in a ROM/Flash memory device. The memory device is one of the I/O devices and the CPU 11 needs to fetch the BIOS 13 from the memory device through the system chipset(s) 12 to boot up the local mainboard 01. In the present invention, the system chipset(s) 12 operates as a bridge interface between the CPU(s) 11 and the BIOS 13. Also, the system chipset(s) 12 is an I/O hub between the CPU(s) 11 and I/O devices (not shown).

The system I/O bus 40, such as LPC (Low Pin Count) or PCI (Peripheral Component Interconnect) based bus (such as PCI, PCI-X, PCI-E) connects the computer host domain 10 with the I/O devices. Also the system I/O bus 40 allows the BIOS 13 to write the check data (BIOS check-point information) to a specific I/O address thereon, such as “0x0080” (or Port 80). In an actual implementation, the system I/O bus 40 may connect the system chipset(s) 12 and the BIOS 13.

The remote monitor module 50 mainly includes a BMC (Baseboard Management Controller) 51, one or more event monitor 52 and a decoder 53. The BMC 51 is a local management controller with firmware, in circuit connection with the computer host domain 10 and the remote management host. It transmits event signals and check data signals and provides remote control/monitor capability to the remote management host through the remote management link(s). Basically, the BMC 51 may be implemented as a dedicated local management controller configured on the local mainboard or on a SMDC (System Management Daughter Card), or as a centralized system-level local management controller for the local mainboards. The BMC 51 may connect with the computer host domain through IPMI-compatible links, including SMBus (System Management Bus), Serial Port link, network interface link or the system I/O bus.

The event monitor(s) 52 is also in circuit connection with the computer host domain 10 and the BMC 51. It detects status signal(s) corresponding to certain initialization events such as reset release, first BIOS fetch and etc. from the computer host domain 10 during system initialization process and generates and transmits event signal Sₑ as the initialization events to the BMC 51. Please refer to FIG. 2A. In an embodiment of the present invention, the event monitor 52 mainly includes a synchronizer 521, a condition checker 522 and an event latch 523.

The synchronizer 521 receives the monitored status signal(s) Sₘ, synchronizing with the system clock and then send to the condition checker 522. The monitored status signal(s) Sₘ may be provided by system hardware components, the system I/O bus 40 or a status monitor (not shown). The condition checker 522 connects between the synchronizer 521 and the event latch 523, and confirms whether the synchronized status signal Sₘ is at a designed voltage level. The event latch 523 latches and remains the event signal Sₑ at a specific voltage level, and transmits to the BMC 51. All the three elements of the event monitor 52 may be realized by circuits with flip-flops; only the detailed actual implementation depends. Besides, for those signals that already has the synchronized system clock, the synchronizer 521 is not essential for the event monitor 52.

FIG. 2B illustrates a practical example of an event monitor for the event of first BIOS fetch. The two signals LPC_FRAME and LPC_RESET are involved in the bus protocol of the LPC (Low Pin Count) bus 41 when the BIOS 13 is first fetched by the CPU 11. LPC_FRAME is used to indicate “starting bus transaction”, while LPC_RESET indicates the reset of LPC bus 41. A system designer may define the voltage levels of the involved signal(s) to determine a condition of an initialization event. In the present embodiment, if signal LPC_RESET is HIGH and signal LPC_FRAME is LOW (actually monitoring LPC_FRAME# and LPC_RESET*), the two signals with these certain voltage levels will be confirmed by the condition checker 522 and then processed by the event latch 523 with an OR-gate and a flip-flop. Comparing to the status signal, the event signal needs to be held at a specific voltage level to indicates if an certain event is happened or not. For the PCI-based system I/O bus, the event monitor 52 may still monitor the event of first BIOS fetch through the similar way as the LPC bus.

Namely, the involved signals and the condition are implementation dependent. The types of system I/O bus and the system chipset actually used in an application will give various definitions to signal conditions for the initialization events. Besides, even the initialization events could be different. For example, an nVIDIA chip such as CK804 or MCP55 is able to access chip initialization information from some specific BIOS, with the access timing earlier than the initialization event of first BIOS fetch. Furthermore, the same signal may also be used for various monitoring tasks. For instance, if the system I/O bus is PCI based, an initialization event of “ROM Strapping” will possibly be monitored by detecting a PCI_RESET*(LOW) signal, along with the initialization event of first BIOS fetch.

The decoder 53 connects to the system I/O bus 40 and decodes the check data written to the specific I/O address “Port 80” on the system I/O bus 40. The decoded check data will be transmitted as check data signal(s) SS to the BMC 51. FIG. 2C illustrates an example for the decoder 53. The bus interface in FIG. 2 monitors the transactions of the system I/O bus 40. A comparator compares the current address with the target address where the BIOS store the check data, and then generates the data latch enable signal. The bus interface also generates “data valid” signal based on the bus protocol of the system I/O bus 40. (If the current data are the check data, it could be latched as an event by the event monitor 52.) Except remote management, the decoder 53 may still connect to an indicator 31 for displaying the check data thereon.

Eventually, through the BMC 51 the remote management host may access the designed event data of the system initialization and the check data of BIOS check-point information. The event monitor of the present invention allows the user to monitor any necessary initialization events.

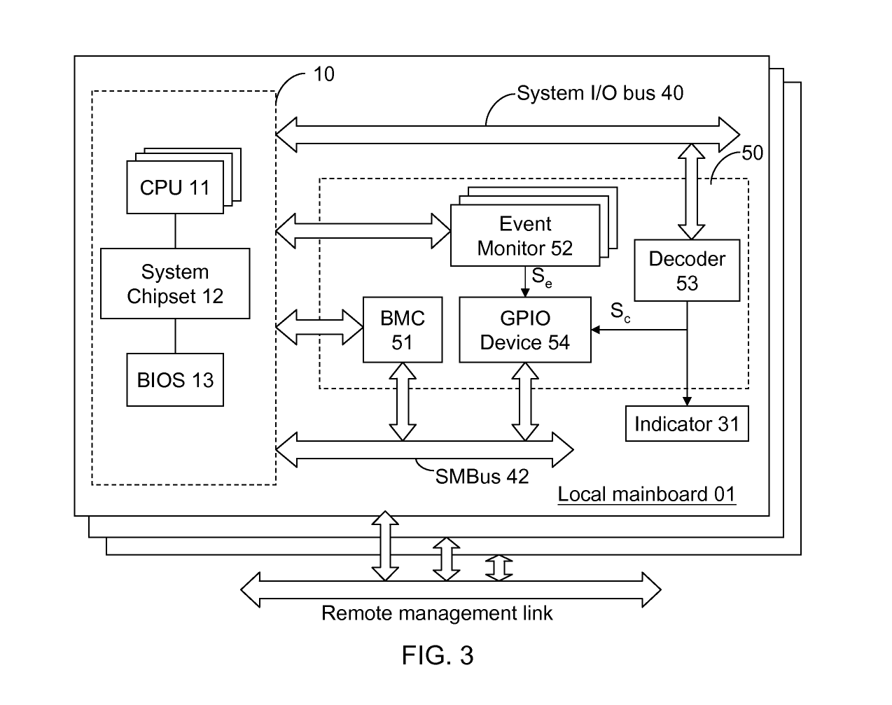

Please refer FIG. 3. In an actual application, the BMC 51 has limited GPIO (General Purpose Input/Output) pins to receive the event signals Sₑ and the check data signals S_{c}, which may not be enough for all these signals. A simple approach is to configure an additional GPIO device 54 to provide sufficient GPIO pins for the signals Sₑ and the check data signals S_{c}, such as a GPIO expander or a controller with spare GPIO pins. And then connect both the BMC 51 and the GPIO device 54 to a SMBus 42 extended from the system chipset 12 in the computer host domain 10. The event signals Sₑ and the check data signals S_{c} will then be transmitted to the GPIO device 54 and accessed by the BMC 51 through the SMBus 42.

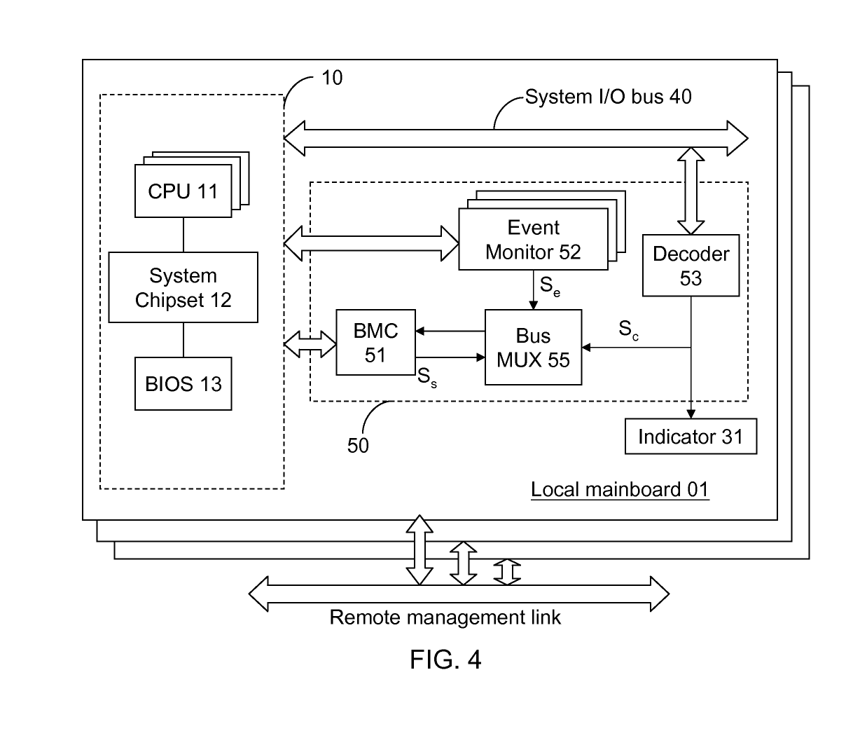

Please refer to FIG. 4. Another solution for the limited GPIO pins of the BMC 51 is to configure an additional bus multiplexer (MUX) 55 connected between the BMC 51, the event monitor(s) 52 and the decoder 53. The event signals Sₑ and the check data signals S_{c} will then be transmitted to the bus multiplexer 55. Then the bus multiplexer 55 will select one type signals from the event signals Sₑ and the check data signals S_{c} to send to the BMC 51 according to selection signal(s) Sₛ from the BMC 51. The selection signal(s) Sₛ may be transmitted from the BMC 51 according to the commands of the remote management host or a selection logic inside the BMC 51.

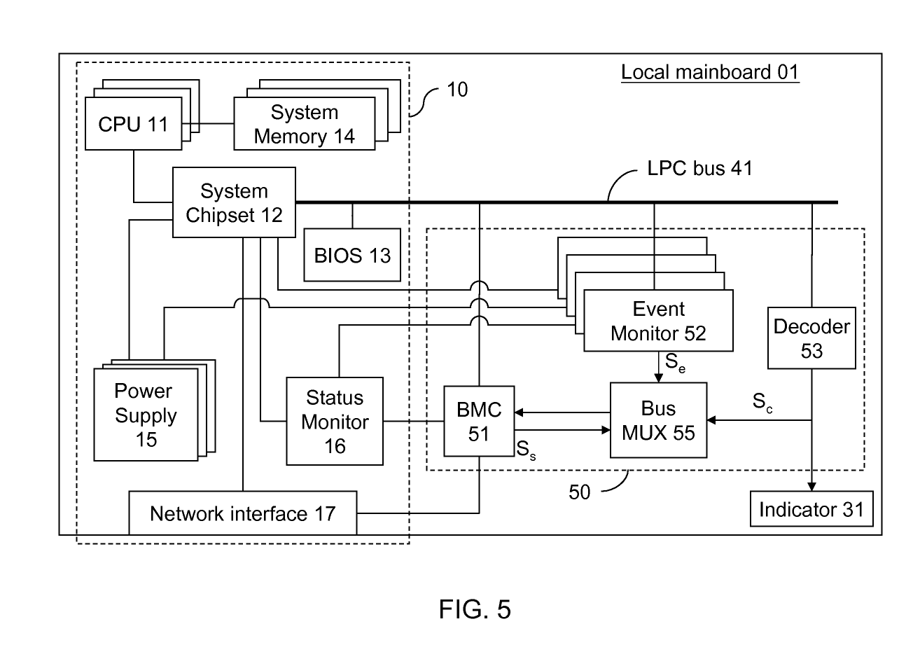

FIG. 5 shows a detailed diagram for the actual application of the local mainboard 01 in FIG. 4. There are four extra event monitors 52 included in the remote monitor module 50. One connects to the system chipset 12, one connecting to the power supply 15; the other two are connected to the LPC bus 41 and a status monitor 16. The system chipset 12 may provide status signals of power-up sequence from power converters (not shown) or the power supply 15. As to the status monitor 16, generally a common hardware monitor controller may be used to monitor system temperature and fan information signals. Some power supply equipped with a power controller may generate one or more status signals. And as mentioned above, some status signals such as bus reset release is already part of the bus protocol for the system I/O bus 40.

Accordingly, the event monitors 52 may gather various status signals during the system initialization process for the BMC 51. Plus with the check data signals from the decoder 53, the remote monitor module 51 may monitor almost every detailed events instantly happening on the local mainboard 01 during the system initialization process. The BMC 51 may connect to a network interface 17, such as a local area network (LAN) module with NIC (Network Interface Controller) and LAN communication port, to transmit aforesaid signals through the remote management link (such as LAN) to the remote management host. Sure the decoder may be omitted from the remote control module for those non-BIOS events during the system initialization process.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A remote monitor module for monitoring at least one initialization event of a computer host domain on a local mainboard, comprising:
a BMC (Baseboard Management Controller) in circuit connection with the computer host domain and a remote management host; and
at least one event monitor in circuit connection with the computer host domain and the BMC, detecting at least one status signal corresponding to the initialization event and generating and transmitting at least one event signal to the BMC.

2. The remote monitor module of claim 1, wherein the event monitor comprises a condition checker and an event latch, the condition checker confirming whether the status signal is at a designed voltage level, the event latch latching to remain the event signal at a specific voltage level and transmitting to the BMC.

3. The remote monitor module of claim 2, wherein the event monitor further comprises a synchronizer for synchronizing the status signal with a system clock of the computer host domain and transmitting the synchronized status signal to the condition checker.

4. The remote monitor module of claim 3, wherein the synchronizer, the condition checker and/or the event latch comprises at least one flip-flop.

5. The remote monitor module of claim 1, wherein the computer host domain comprises at least one CPU, a BIOS (Basic Input/Output System) and at least one system chipset operating as a bridge interface between the CPU and the BIOS, the system chipset connecting with the BIOS through a system I/O bus.

6. The remote monitor module of claim 5, wherein the event monitor connects with the system I/O bus to monitor the initialization event of first BIOS fetch through certain signals involved in the bus protocol of the system I/O bus.

7. The remote monitor module of claim 5, wherein the system I/O bus is a LPC (Low Pin Count) bus or PCI (Peripheral Component Interconnect) based bus.

8. The remote monitor module of claim 5 further comprising a decoder that connects with the system I/O bus and the BMC, the decoder decoding a plurality of check data written by the BIOS, and generating and transmitting at least one check data signal to the BMC.

9. The remote monitor module of claim 8 further comprising a GPIO (General Purpose Input/Output) device to provide a plurality of GPIO pins for receiving the event signal and/or the check data signal.

10. The remote monitor module of claim 9, wherein both the BMC and the GPIO device connect to a SMBus (System Management Bus) extended from the system chipset of the computer host domain, the event signal and the check data signal being accessed by the BMC through the SMBus.

11. The remote monitor module of claim 8, wherein the check data comprises check-point information during the BIOS initialization.

12. The remote monitor module of claim 8 further comprising a bus multiplexer that receives and selects one of the event signal and the check data signal according to at least one selection signal from the BMC, and sends the selected event signal or check data signal to the BMC.

13. The remote monitor module of claim 8, wherein the check data signal is transmitted to an indicator for displaying the check data thereon.

14. The remote monitor module of claim 8, wherein the BMC transmits the event signal and/or the check data signal to the remote management host through at least one remote management link.

15. The remote monitor module of claim 14, wherein the remote management link is compatible with communication links defined in the IPMI (Intelligent Platform Management Interface) Specification.

16. The remote monitor module of claim 1, wherein the BMC is a centralized system-level local management controller or a dedicated local management controller configured on the local mainboard or on a SMDC (System Management Daughter Card).

17. The remote monitor module of claim 1, wherein the BMC may connect with the computer host domain through SMBus, Serial Port link, network interface link or the system I/O bus.

18. The remote monitor module of claim 1, wherein the event monitor connects with at least one power supply of the computer host domain to detect the status signal.

19. The remote monitor module of claim 1, wherein the event monitor connects with a status monitor of the computer host domain to detect the status signal.

20. The remote monitor module of claim 19, wherein the status monitor is a hardware monitor controller.
